(19) United States
(12) Patent Application Publication
(10) Pub. No.: US 2025/0286710 A1
(43) Pub. Date: Sep. 11, 2025

(54) METHOD AND SYSTEM FOR ENCODING MEDIA TRANSMITTED AND RECEIVED IN STREAMING FORM BETWEEN USERS

(71) Applicant: LINE Plus Corporation, Seongnam-si, (KR)

(72) Inventors: Baek Bum PYUN, Seongnam -si (KR); Charles Philippe A HUBAIN, Seongnam-si (KR)

(73) Assignee: LINE Plus Corporation, Seongnam-si, (KR)

(21) Appl. No.: 19/217,512

(22) Filed: May 23, 2025

Related U.S. Application Data
(63) Continuation of application No. PCT/KR2023/013538, filed on Sep. 8, 2023.

(30) Foreign Application Priority Data
Nov. 25, 2022 (KR) 10-2022-0160256

(51) Int. Cl. H04L 9/08

(52) U.S. Cl. CPC H04L 9/0869

(57) ABSTRACT

Disclosed are a method and system for encoding media transmitted and received in a streaming form between users. The encoding method according to an embodiment may comprise the steps of: generating a plurality of encoded unit files that are encoded with a random key, by using a media file to be transmitted in a streaming form; generating a hash value of each of the plurality of encoded unit files; and transmitting a file set including the plurality of encoded unit files and a proof including the hash value of each of the plurality of encoded unit files, to a server for providing a function of transmitting the media file in a streaming form.

### CROSS-REFERENCE TO RELATED APPLICATION(S)

This application is bypass continuation of International Application No. PCT/KR2023/013538, filed Sep. 8, 2023, which claims the benefits of Korean Patent Application No. 10-2022-0160256, filed on Nov. 25, 2022, in the Korean Intellectual Property Office, the disclosures of each of which are herein incorporated by reference in their entireties.

### BACKGROUND

### 1. FIELD

The following description relates to a method and system for encrypting media transmitted and received in streaming format between users.

### 2. DESCRIPTION OF RELATED ART

Conventional encryption technology, including Digital Rights Management (DRM) for media transmitted and received in streaming format, is encryption technology between a server of a media provision service and a user, and mainly aims to allow only an authorized user to play media.

To implement encryption between users, that is, end-to-end encryption, a server of a media provision service needs to provide the streaming functionality, but not know the contents of media. However, the conventional encryption has the issue that it is difficult to encrypt media transmitted and received in streaming format since full access to all target files of the media is required.

### SUMMARY

Some example embodiments provide an encryption method and system that may transmit a plurality of unit files, corresponding collectively to a media file, such that a server providing a streaming functionality may transmit each unit file without knowing the contents of the media file and such that a reception side may play the media file even with a portion of the media file by maintaining an encryption state between users even though the media file is split into unit files to be transmitted in streaming format (e.g., chunk-basis files to be transmitted and received in streaming format).

In an encryption method of a computer device including at least one processor, the encryption method includes generating, by the at least one processor, a plurality of encrypted unit files encrypted with a random key, the plurality of encrypted unit files based on a media file to be transmitted in a streaming format, generating, by the at least one processor, a plurality of hash values corresponding respectively to each of the plurality of encrypted unit files, and transmitting, by the at least one processor, the plurality of encrypted unit files and the plurality of hash values to a server configured to provide a transmission function of the streaming format for the media file.

According to some example embodiments, the encryption method may further include encrypting, by the at least one processor, the random key with a private key for end-to-end encryption, and transmitting, by the at least one processor, the random key encrypted with the private key to a terminal of a recipient that is allowed to play the media file.

According to some example embodiments, the encryption method may further include receiving, by the at least one processor from a terminal of a provider of the media file, the random key encrypted with a private key of the provider for end-to-end encryption, and acquiring, by the at least one processor, the random key by decrypting the random key encrypted with the private key of the provider using a public key of the provider shared for the end-to-end encryption.

According to some example embodiments, the encryption method may further include receiving, by the at least one processor from the server, the plurality of hash values, receiving, by the at least one processor from the server, a first encrypted unit file among the plurality of encrypted unit files; generating, by the at least one processor, a hash value of the first encrypted unit file using the random key acquired through a terminal of a provider of the media file; and authenticating, by the at least one processor, the first encrypted unit file by comparing the generated hash value and a received hash value of the plurality of received hash values corresponding with the first encrypted unit file.

According to some example embodiments, the encryption method may further include receiving, by the at least one processor from the server, a first encrypted unit file among the plurality of encrypted unit files; and acquiring, by the at least one processor, a first unit file by decrypting the first encrypted unit file using the random key acquired through a terminal of a provider of the media file.

According to some example embodiments, the encryption method may further include receiving, by the at least one processor from the server, the plurality of hash values, requesting, by the at least one processor, the server for a unit file of a specific order or a specific range based on an order of a hash value of the plurality of hash values, and receiving, by the at least one processor from the server, an encrypted unit file among the plurality of encrypted unit files corresponding to the specific order or the specific range.

According to some example embodiments a computer program stored in a computer-readable recording medium may be configured to execute the method on a computer device in conjunction with the computer device.

According to some example embodiments, a computer-readable recording medium may store a program to execute the method on a computer device.

Some example embodiments disclose a computer device including at least one processor configured to execute computer-readable instructions, wherein the at least one processor is configured to cause the computer device to receive, from a terminal of a provider of a media file to be transmitted in a streaming format, a plurality of encrypted unit files generated for the media file and a plurality of hash values corresponding respectively to each of the plurality of encrypted unit files, transmit the plurality of hash values to a terminal of a recipient that desires to receive the media file in the streaming format, receive, from the terminal of the recipient, a request for a unit file of a specific order or a specific range based on an order of a hash value of the plurality of hash values, and transmit, to the terminal of the recipient, an encrypted unit file of the plurality of encrypted unit files corresponding to the specific order or the specific range.

By maintaining an encryption state between users even though a media file is split into unit files to be transmitted in streaming format (e.g., chunk-basis files to be transmitted and received in streaming format), a server providing the streaming functionality may transmit each unit file without knowing the contents of the media file and a reception side may play the media file even with a portion of the media file.

### BRIEF DESCRIPTION OF DRAWINGS

FIG. 1 is a diagram illustrating an example of a network environment according to some example embodiments.

FIG. 2 is a block diagram illustrating an example of a computer device according to some example embodiments.

FIG. 3 illustrates an example of a process of providing a media file in streaming format in some example embodiments.

FIG. 4 is a flowchart illustrating an example of an encryption method of a provider side in some example embodiments.

FIG. 5 is a flowchart illustrating an example of an encryption method of a recipient side in some example embodiments.

FIG. 6 is a flowchart illustrating an example of an encryption method of a server side in some example embodiments.

FIG. 7 illustrates an example of a process of encrypting a unit file, generating a hash value of the unit file, and authenticating the unit file in some example embodiments.

### DETAILED DESCRIPTION

Hereinafter, some example embodiments will be described in detail with reference to the accompanying drawings.

An encryption system according to some example embodiments may be implemented by at least one computer device. Here, a computer program according to some example embodiments may be installed and executed on the computer device, and the computer device may perform an encryption method according to some example embodiments under control of the executed computer program. The aforementioned computer program may be stored in a computer-readable storage medium to computer-implement the encryption method in conjunction with the computer device.

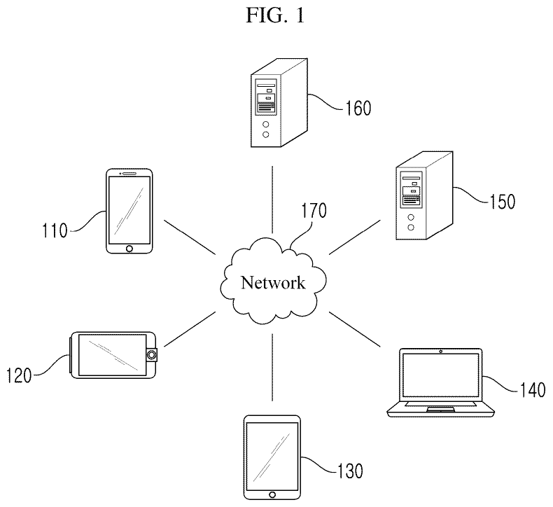

FIG. 1 illustrates an example of a network environment according to some example embodiments. Referring to FIG. 1, the network environment may include a plurality of electronic devices 110, 120, 130, and/or 140, a plurality of servers 150 and/or 160, and/or a network 170. FIG. 1 is provided as an example only. The number of electronic devices and/or the number of servers is not limited thereto. Also, the network environment of FIG. 1 is provided as an example only among environments applicable to the example embodiments, and the environment applicable to the example embodiments is not limited to the network environment of FIG. 1.

Each, or one or more, of the plurality of electronic devices 110, 120, 130, and/or 140 may be a fixed terminal or a mobile terminal that is configured as a computer device. For example, the plurality of electronic devices 110, 120, 130, and/or 140 may be a smartphone, a mobile phone, a navigation device, a computer, a laptop computer, a digital broadcasting terminal, a personal digital assistant (PDA), a portable multimedia player (PMP), a tablet personal computer (PC), and/or the like. For example, although FIG. 1 illustrates a shape of a smartphone as an example of the electronic device 110, the electronic device 110 used herein may refer to one of various types of physical computer devices capable of communicating with other electronic devices 120, 130, and/or 140 and/or the servers 150 and/or 160 over the network 170 in a wireless or wired communication manner.

The communication scheme is not limited and may include a near field wireless communication scheme between devices as well as a communication scheme using a communication network (e.g., mobile communication network, wired Internet, wireless Internet, and/or broadcasting network) includable in the network 170. For example, the network 170 may include at least one network among networks that include a personal area network (PAN), a local area network (LAN), a campus area network (CAN), a metropolitan area network (MAN), a wide area network (WAN), a broadband network (BBN), and/or the Internet. Also, the network 170 may include at least one of network topologies that include a bus network, a star network, a ring network, a mesh network, a star-bus network, a tree and/or hierarchical network, and/or the like. However, they are provided as examples only.

Each, or one or more, of the servers 150 and/or 160 may be implemented as a computer device or plurality of computer devices that provides an instruction, a code, a file, content, a service, etc., through communication with the plurality of electronic devices 110, 120, 130, and/or 140 over the network 170. For example, the server 150 may be a system that provides a service to the plurality of electronic devices 110, 120, 130, and/or 140 connected through the network 170.

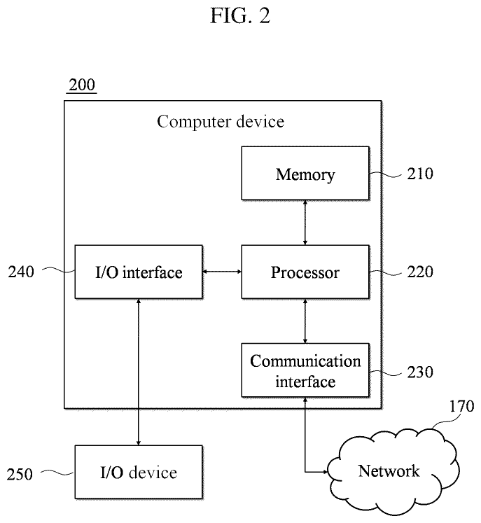

FIG. 2 is a block diagram illustrating an example of a computer device according to some example embodiments. Each, or one or more, of the plurality of electronic devices 110, 120, 130, and/or 140 or each of the servers 150 and/or 160 described above may be implemented by a computer device 200 of FIG. 2.

Referring to FIG. 2, the computer device 200 may include a memory 210, a processor 220, a communication interface 230, and/or an input/output (I/O) interface 240. The memory 210 may include a permanent mass storage device, such as a random access memory (RAM), a read only memory (ROM), and/or a disk drive, as a computer-readable recording medium. The permanent mass storage device, such as ROM and/or a disk drive, may be included in the computer device 200 as a permanent storage device separate from the memory 210. Also, an operating system (OS) and at least one program code may be stored in the memory 210. Such software components may be loaded to the memory 210 from another computer-readable recording medium separate from the memory 210. The other computer-readable recording medium may include a computer-readable recording medium, for example, a floppy drive, a disk, a tape, a DVD/CD-ROM drive, a memory card, etc. According to some example embodiments, software components may be loaded to the memory 210 through the communication interface 230, instead of the computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and/or I/O operations. The instructions may be provided from the memory 210 and/or the communication interface 230 to the processor 220. For example, the processor 220 may be configured to execute received instructions in response to the program code stored in the storage device, such as the memory 210.

The communication interface 230 may provide a function for communication between the communication system 200 and another apparatus (e.g., the aforementioned storage devices) over the network 170. For example, the processor 220 of the computer device 200 may deliver a request and/or an instruction created based on a program code stored in the storage device such as the memory 210, data, and/or a file, to other apparatuses over the network 170 under control of the communication interface 230. Inversely, a signal, an instruction, data, a file, etc., from another apparatus may be received at the computer device 200 through the network 170 and the communication interface 230 of the computer device 200. A signal, an instruction, data, etc., received through the communication interface 230 may be delivered to the processor 220 and/or the memory 210, and/or a file, etc., may be stored in a storage medium (e.g., the permanent storage device) further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. At least one of the I/O device 250 may be configured as a single apparatus with the computer device 200. For example, a touchscreen, a microphone, a speaker, and/or the like, like a smartphone, may be implemented to be included in the computer device 200.

In some example embodiments, the computer device 200 may include the number of components greater than or less than the number of components shown in FIG. 2. However, there is no need to clearly illustrate many conventional components. For example, the computer device 200 may include at least a portion of the I/O device 250, or may further include other components, for example, a transceiver, a database, etc.

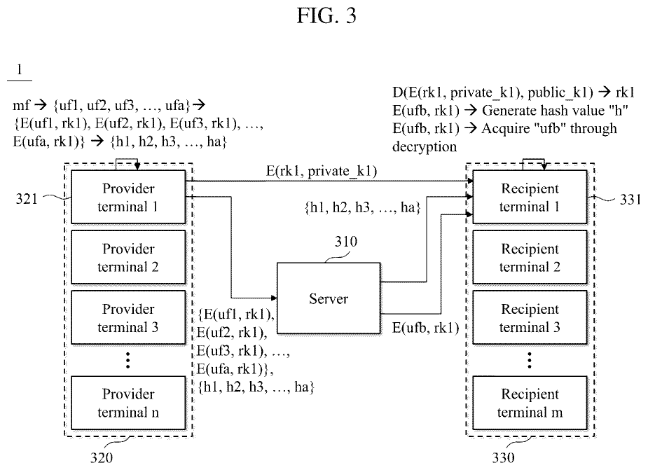

FIG. 3 illustrates an example of a system for providing a media file in streaming format in some example embodiments. FIG. 3 illustrates a system 1 including a server 310, a plurality of provider terminals 320, and a plurality of recipient terminals 330.

The server 310 may be implemented by at least one physical electronic device that provides a specific service to a plurality of users. For example, each, or one or more, of the at least one physical electronic device may correspond to the computer device 200 described above with reference to FIG. 2.

The plurality of provider terminals 320 and the plurality of recipient terminals 330 may be physical electronic devices of the plurality of users to which the server 310 provides a service, respectively. The physical electronic device may correspond to the computer device 200 described above with reference to FIG. 2.

The specific service provided from the server 310 may include a service that at least provides a media file of a first user to a second user in streaming format. The first user may be represented as a provider that provides the media file, and the second user may be represented as a recipient that desires to receive and play the media file. The provider may be a recipient for another media file, and the recipient may also be a provider that provides its own media file. For example, a computer program of an application form that is installed on a terminal of a user (provider and/or recipient) to be provided with the service of the server 310 may include both the functionality for operating as the provider and the functionality for operating as the recipient.

In some example embodiments, the server 310 may provide additional various services to users. For example, the server 310 may provide an instant messaging service to users and may also provide the media file of the first user to the second user in streaming format in a process of providing the instant messaging service.

An example of a process of delivering a media file of a provider terminal 1 321 to a recipient terminal 1 331 in streaming format is shown in FIG. 3. In some example embodiments, the media file may be included in messages transmitted and received through a session established between an account of the provider and an account of the recipient in the instant messaging service. Messages transmitted and received through the session in the instant messaging service may be encrypted with a private key based on end-to-end encryption (E2EE) technology regardless of whether the media file is included, and may be delivered. A target to be encrypted may include contents of a message (e.g., plain text type data). For example, when the provider desires to transmit a message through the session established between an account of the provider, a user of the provider terminal 1 321, and an account of the recipient, a user of the recipient terminal 1 331, the provider terminal 1 321 may encrypt (content of) the message with a private key of the provider through end-to-end encryption technology and may transmit the same to the recipient terminal 1 331. Transmission of the encrypted message may be routed between the provider terminal 1 321 and the recipient terminal 1 331 through the server 310 that provides the instant messaging service. The private key of the provider may be determined for each device in which an application for the instant messaging service is installed. For example, when the provider uses a device 1 and a device 2 each in which the application is installed, a first private key for the device 1 and a second private key for the device 2 may be generated. Here, the first private key and the second private key may differ from each other.

In this environment, a media file to be provided in streaming format may be encrypted and provided for each, or one or more, unit file, such as a unit chunk file, to make it possible for the server 310 providing the instant messaging service to provide the media file to the recipient in streaming format, as described below.

The provider terminal 1 321 may split a media file 1 “mf1” to be provided in streaming format into a plurality of unit files {uf1, uf2, uf3, . . . , ufa}. For example, the unit file may be a unit chunk file to be provided to the recipient in streaming format. the provider terminal 1 321 may generate a plurality of encrypted unit files {E(uf1, rk1), E(uf2, rk1), E(uf3, rk1), . . . , E(ufa, rk1)} by encrypting each, or one or more, of the plurality of unit files {uf1, uf2, uf3, . . . , ufa} with a random key 1 “rk1”. For example, one of various encrypting algorithms, such as DES, double DES, triple DES, AES, IDEA, SEED, Blowfish, ARIA, and the like, may be used to encrypt each, or one or more, of the plurality of unit files.

It is assumed that, between the provider terminal 1 321 and the recipient terminal 1 331, the recipient is aware of a public key “public_k1” of the provider based on end-to-end encryption technology. The end-to-end encryption refers to technology that encrypts data until the data reaches a destination of the data from a transmission point of the data, making it more difficult or impossible to read the contents of the data since the data is encrypted, even if someone intercepts the data in the middle or the server 310 is hacked and the stored data is leaked. It provides a service that allows only an end to an end, that is, only a provider and a recipient of the data to view the original text. The provider terminal 1 321 may encrypt the random key 1 “rk1” with a private key “private_k1” of the provider for end-to-end encryption and may generate an encrypted random key 1 “E(rk1, private_k1)”. Also, the provider terminal 1 321 may deliver the encrypted random key 1 “E(rk1, private_k1)” to the recipient terminal 1 331. In this case, the recipient terminal 1 331 may acquire the random key 1“rk1” by decrypting the encrypted random key 1 “E(rk1, private_k1)” with the public key “public_k1” of the provider.

The provider terminal 1 321 may generate a set of hash values {h1, h2, h3, . . . , ha} by generating a hash value of each, or one or more, of the plurality of encrypted unit files {E(uf1, rk1), E(uf2, rk1), E(uf3, rk1), . . . , E(ufa, rk1)}. For example, the provider terminal 1 321 may generate hash values through a hash function that uses each, or one or more, of the plurality of encrypted unit files {E(uf1, rk1), E(uf2, rk1), E(uf3, rk1), . . . , E(ufa, rk1)} and the random key 1 “rk1” as input.

The provider terminal 1 321 may transmit the plurality of encrypted unit files {E(uf1, rk1), E(uf2, rk1), E(uf3, rk1), . . . , E(ufa, rk1)} and the set of hash values {h1, h2, h3, . . . , ha} to the server 310. Here, since the unit file encrypted with the random key 1 “rk1” is transmitted to the server 310, the server 310 may not know the contents of the media file. Nevertheless, the server 310 may provide the plurality of encrypted unit files {E(uf1, rk1), E(uf2, rk1), E(uf3, rk1), . . . , E(ufa, rk1)} to the recipient terminal 1 331 in streaming format. An encrypted unit file of specific order or specific range may be identified based on the set of hash values {h1, h2, h3, . . . , ha}. The server 310 may transmit the set of hash values {h1, h2, h3, . . . , ha} to the recipient terminal 1 331. For example, the recipient terminal 1 331 may specify the encrypted unit file of the specific order or the specific range among the plurality of encrypted unit files {E(uf1, rk1), E(uf2, rk1), E(uf3, rk1), . . . , E(ufa, rk1)} using the set of hash values {h1, h2, h3, . . . , ha}. The server 310 may stream a media file from the encrypted unit file E(ufb, rk1) of the specific order or specific range specified by the recipient terminal 1 331.

The recipient terminal 1 331 may generate a hash value “h” of the encrypted unit file E(ufb, rk1) using the random key 1 “rk1”. Then, the recipient terminal 1 331 may authenticate the encrypted unit file E(ufb, rk1) by comparing the generated hash value “h” and the set of hash values {h1, h2, h3, . . . , ha}. For example, when the hash value “h” is the same as the hash value included in the set of hash values {h1, h2, h3, . . . , ha}, the encrypted unit file E(ufb, rk1) may be authenticated. For example, Hash-based Message Authentication Code (HMAC) technology may be utilized. HMAC may be used to simultaneously perform data integrity and authenticity verification of a message, like regular MAC.

The recipient terminal 1 331 may acquire a unit file “ufb” by decrypting the encrypted unit file E(ufb, rk1) using the random key 1 “rk1”. For example, the recipient terminal 1 331 may play a media file from the unit file “ufb”.

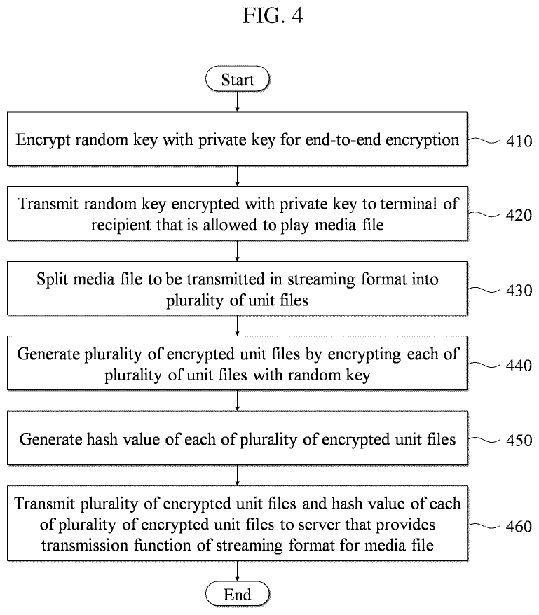

FIG. 4 is a flowchart illustrating an example of an encryption method of a provider side in some example embodiments. The encryption method according to some example embodiments may be performed by the computer device 200 that implements a terminal of a provider. The processor 220 of the computer device 200 may be implemented to execute a control instruction according to a code of at least one computer program or a code of an operating system included in the memory 210. The processor 220 may control the computer device 200 to perform operations 410 to 460 included in the method of FIG. 4 in response to a control instruction provided from a code stored in the computer device 200.

In operation 410, the computer device 200 may encrypt a random key with a private key for end-to-end encryption. The random key may be used to encrypt each, or one or more, of a plurality of unit files split from a media file.

In operation 420, the computer device 200 may transmit the random key encrypted with the private key to a terminal of a recipient that is allowed to play the media file. The terminal of the recipient may acquire a random key of a provider by decrypting the random key encrypted with a private key of the provider using a public key of the provider shared for the end-to-end encryption. For example, a terminal of the provider and the terminal of the recipient may share the random key in advance using end-to-end encryption technology.

In operation 430, the computer device 200 may split the media file to be transmitted in streaming format into a plurality of unit files. An example of splitting the media file 1 “mf1” into the plurality of unit files {uf1, uf2, uf3, . . . , ufa} is described above with reference to FIG. 3.

In operation 440, the computer device 200 may generate a plurality of encrypted unit files by encrypting each, or one or more, of the plurality of unit files with the random key. An example of generating the plurality of encrypted unit files {E(uf1, rk1), E(uf2, rk1), E(uf3 , rk1), . . . , E(ufa, rk1)} by encrypting each, or one or more, of the plurality of unit files {uf1, uf2, uf3, . . . , ufa} with the random key 1 “rk1” is described above with reference to FIG. 3.

Some example embodiments splitting the media file into the plurality of unit files (operation 430) and then generating the plurality of encrypted unit files by encrypting each of the split plurality of unit files with the random key (operation 440). However, in some example embodiments, the computer device 200 may initially encrypt the media file and then may split the encrypted media file into the plurality of encrypted unit files. This may be used when the media file has the same data size before encryption and after encryption of the media file. For example, when the data size before encryption of the media file and the data size after encryption of the media file are the same, the same plurality of encrypted unit files may be acquired in both cases, a case of encrypting the media file with the random key and then splitting the same into the plurality of encrypted unit files and a case of splitting the media file into the plurality of unit files and then encrypting each of the plurality of unit files. Therefore, in both cases, each, or one or more, of the plurality of encrypted unit files may be individually decrypted through the random key.

In operation 450, the computer device 200 may generate a hash value of each, or one or more of the plurality of encrypted unit files. An example of generating the hash value of each, or one or more, of the plurality of encrypted unit files {E(uf1, rk1), E(uf2, rk1), E(uf3, rk1), . . . , E(ufa, rk1)} and generating the set of hash values {h1, h2, h3, . . . , ha} is described above with reference to FIG. 3.

In operation 460, the computer device 200 may transmit the plurality of encrypted unit files and the hash value of each of the plurality of encrypted unit files to a server that provides a transmission function of streaming format for the media file. For example, the computer device 200 may transmit the plurality of encrypted unit files {E(uf1, rk1), E(uf2, rk1), E(uf3, rk1), . . . , E(ufa, rk1)} and the set of hash values {h1, h2, h3, . . . , ha} to the server 310.

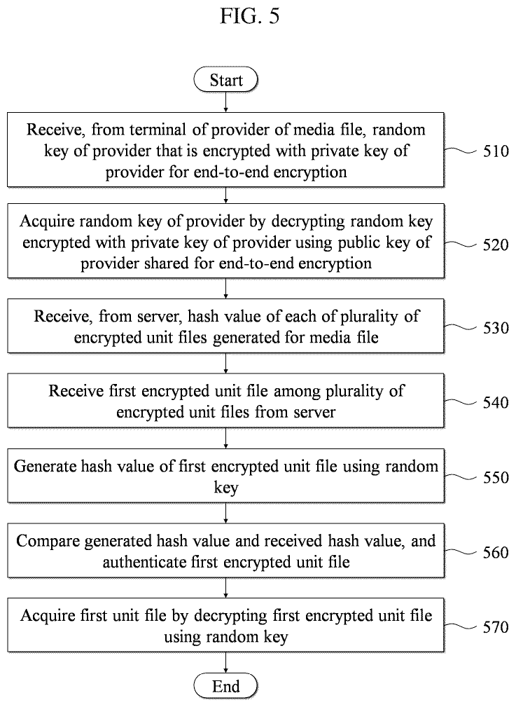

FIG. 5 is a flowchart illustrating an example of an encryption method of a recipient side in some example embodiments. The encryption method according to some example embodiments may be performed by the computer device 200 that implements a terminal of a recipient. As described above, each, or one or more, of users that are provided with a service from the server 310 may be a provider, and may also be a recipient. For example, the provider and the recipient are simply classified based on a media file, and a terminal of a single user may provide all of functionality of a terminal of the provider and/or functionality of the terminal of the recipient. For example, a computer program as an application installed on the terminal of the user may include all of functions for the provider and/or functions for the recipient with respect to the media file. The processor 220 of the computer device 200 may be implemented to execute a control instruction according to a code of at least one computer program and/or a code of an OS included in the memory 210. The processor 220 may control the computer device 200 to perform operations 510 to 570 included in the method of FIG. 5 in response to a control instruction provided from a code stored in the computer device 200.

In operation 510, the computer device 200 may receive, from a terminal of a provider of a media file, a random key of the provider that is encrypted with a private key of the provider for end-to-end encryption. For example, that the encrypted random key 1 “E (rk1, private_k1)” may be generated by encrypting the random key 1 “rk1” with the private key “private_k1” of the provider for the end-to-end encryption, and the encrypted random key 1 “E (rk1, private_k1)” may be transmitted to the recipient is described above with reference to FIG. 3.

In operation 520, the computer device 200 may acquire the random key of the provider by decrypting the random key encrypted with the private of the provider using a public key of the provider shared for the end-to-end encryption. An example in which the recipient side may acquire the random key 1 “rk1” by decrypting the encrypted random key 1 “E (rk1, private_k1)” with the public key “public_k1” of the provider is described above with reference to FIG. 3.

In operation 530, the computer device 200 may receive, from the server, a hash value of each, or one or more, of a plurality of encrypted unit files generated for the media file. An example of generating the plurality of encrypted unit files {E(uf1, rk1), E(uf2, rk1), E(uf3, rk1), . . . , E(ufa, rk1)} by encrypting each of the plurality of unit files {uf1, uf2, uf3, . . . , ufa} with the random key 1 “rk1” and generating the set of hash values {h1, h2, h3, . . . , ha} by generating the hash value of each, or one or more, of the plurality of encrypted unit files {E(uf1, rk1), E(uf2, rk1), E(uf3, rk1), . . . , E(ufa, rk1)} is described above with reference to FIG. 3. The plurality of encrypted unit files {E(uf1, rk1), E(uf2, rk1), E(uf3, rk1), . . . , E(ufa, rk1)} and the set of hash values {h1, h2, h3, . . . , ha} may be delivered from the provider to the server, and the computer device 200 may receive the set of hash values {h1, h2, h3, . . . , ha} through the server.

In operation 540, the computer device 200 may receive a first encrypted unit file among the plurality of encrypted unit files from the server. The computer device 200 may request the server for a unit file of specific order or specific range based on order of the hash value, and may receive, from the server, an encrypted unit file corresponding to the specific order or the specific range among the plurality of encrypted unit files.

In operation 550, the computer device 200 may generate a hash value of the first encrypted unit file using the random key. For example, the computer device 200 may generate a hash value-based message authentication code as the hash value of the first encrypted unit file using HMAC and the random key.

In operation 560, the computer device 200 may compare the generated hash value and the received hash value, and may authenticate the first encrypted unit file. The received hash value may be the aforementioned set of hash values {h1, h2, h3, . . . , ha}, and when the hash value of the first encrypted unit file is included in the set of hash values {h1, h2, h3, . . . , ha}, the computer device 200 may authenticate the first encrypted unit file.

In operation 570, the computer device 200 may acquire a first unit file by decrypting the first encrypted unit file using the random key. As described above, the unit file may be encrypted at the terminal of the provider using the random key, and the computer device 200 as the terminal of the recipient may decrypt the first encrypted unit file using the random key.

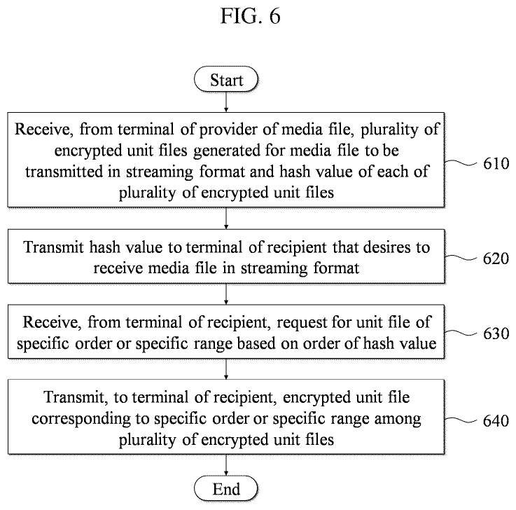

FIG. 6 is a flowchart illustrating an encryption method of a server side in some example embodiments. The encryption method according to some example embodiments may be performed by the computer device 200 that implements a server. The processor 220 of the computer device 200 may be implemented to execute a control instruction according to a code of at least one computer program and/or a code of an OS included in the memory 210. The processor 220 may control the computer device 200 to perform operations 610 to 640 included in the method of FIG. 6 in response to a control instruction provided from a code stored in the computer device 200.

In operation 610, the computer device 200 may receive, from a terminal of a provider of a media file, a plurality of encrypted unit files generated for the media file to be transmitted in streaming format and a hash value of each, or one or more, of the plurality of encrypted unit files. The plurality of encrypted unit files may be generated by encrypting, at the terminal of the provider, each, or one or more, of a plurality of unit files split from the media file using a random key.

In operation 620, the computer device 200 may transmit the hash value to a terminal of a recipient that desires to receive the media file in streaming format. Then, the terminal of the recipient may authenticate each, or one or more, of the encrypted unit files transmitted in streaming format using the transmitted hash value.

In operation 630, the computer device 200 may receive, from the terminal of the recipient, a request for a unit file of specific order or specific range based on order of the hash value. Since the order of the hash value substantially corresponds to the order of encrypted unit files, the terminal of the recipient may specify the order or range of a unit file of which transmission is to be requested using the transmitted hash value.

In operation 640, the computer device 200 may transmit, to the terminal of the recipient, an encrypted unit file corresponding to the specific order or the specific range among the plurality of encrypted unit files. For example, a hash value of the encrypted unit file corresponding to the specific order or the specific range may be generated at the terminal of the recipient using a random key shared in advance based on end-to-end encryption from the terminal of the provider. The encrypted unit file corresponding to the specific order or the specific range may be authenticated at the terminal of the recipient through comparison between the generated hash value and the transmitted hash value. The encrypted unit file corresponding to the specific order or the specific range may be decrypted at the terminal of the recipient using a random key shared in advance based on end-to-end encryption from the terminal of the provider. This process is described above with reference to FIG. 5.

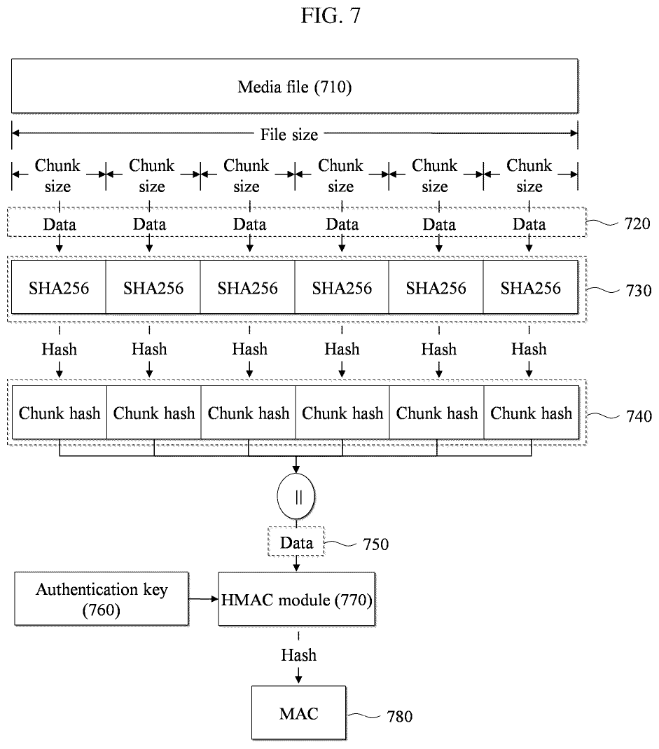

FIG. 7 illustrates an example of a process of encrypting a unit file, generating a hash value of the unit file, and authenticating the unit file in some example embodiments. FIG. 7 illustrates an example of splitting a media file 710 into a plurality of chunks shown in a first box 720 indicated with dotted lines. Each, or one or more, of the plurality of chunks may be encrypted with a random key. Hash values of the plurality of encrypted chunks may be generated using a hash function of SHA256 module shown in a second box 730 indicated with dotted lines. A third box 740 indicated with dotted lines may represent hash values of the plurality of encrypted chunks.

A reception side may generate a message authentication code (MAC) 780 that is a hash value using an authentication key 760 corresponding to the aforementioned random key and an HMAC module 770 for an encrypted specific chunk as shown in a fourth box 750 indicated with dotted lines. The message authentication code 780 and the third box 740 may authenticate the encrypted specific chunk shown in the fourth box 750 indicated with dotted lines through comparison between the hash values of the respective encrypted plurality of chunks.

The performance of the encryption method according to some example embodiments may be as shown in Table 1 below. Here, ‘Csize’ denotes a size of a chunk (unit file), and ‘Fsize’ denotes a size of a media file.

TABLE 1

| Access | Generation | Verification | Storage | Transmission |
|---|---|---|---|---|
| granularity | Cost | Cost | Cost | Cost |
| C_{size} | O(F_{size}) | O(F_{size}/C_{size}) | O(1) | O(F_{size}/C_{size}) |

The smaller the size of the unit file for streaming, such as a chunk, the freer exploration is possible when playing the media file and a waiting time may decrease. However, as the number of unit files increases due to a decrease in the size of the unit file, the number of hash values of unit files generated with a certain size increases and accordingly, a size of a set of hash values may become very large. For example, in the case of splitting a 16 Mib media file into chunks of 64 B, the set of hash values may have the size of 7.750 MiB when a single hash value has the size of 32 B. In the case of splitting a 64 MiB media file into chunks of 64 B, the set of hash values may have the size of 31. 750 MiB when a single hash value has the size of 32 B. On the other hand, in the case of splitting the media file into chunks of 1 KiB under the same conditions, the set of hash values may have the size of 496.000 KiB for the 16 MiB media file and the set of hash values may have the size of 1.984 MiB for the 64 MiB media file, which shows that the size of hash values may be significantly reduced. That is, the size of the set of hash values to be additionally delivered to the media file may be appropriately adjusted by adjusting the size of the unit file.

As described, according to some example embodiments, by maintaining an encryption state between users even though a media file is split into unit files to be transmitted in the streaming format (e.g., a chunk-basis file for transmission and reception in the streaming format), a server providing the streaming functionality may transmit each unit file without knowing the contents of the media file and a reception side may play the media file even with a portion of the media file. Accordingly, a system 1 according to some example embodiments may allow a provider terminal 320 to provide a recipient terminal 330 with a media file for streaming, via a server 310, with increased (e.g., end-to-end) security. For example, a media file transmitted by the provider terminal 320 may be more securely transmitted and/or streamed to the recipient terminal. For example, a more secure connection may be established between the provider terminal 320 and the recipient terminal 330 for streaming media according to example embodiments.

The systems and/or apparatuses described herein may be implemented using hardware components and/or combination of hardware components and software components. For example, the apparatuses and/or the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, and/or any other device capable of responding to and executing instructions in a defined manner. The processing device may run an operating system (OS) and/or one or more software applications that run on the OS. The processing device also may access, store, manipulate, process, and/or create data in response to execution of the software. For purpose of simplicity, the description of a processing device is used as singular; however, one skilled in the art will appreciate that a processing device may include multiple processing elements and/or multiple types of processing elements. For example, a processing device may include multiple processors and/or a processor and/or a controller. In addition, different processing configurations are possible, such as parallel processors.

The software may include a computer program, a piece of code, an instruction, and/or some combinations thereof, for independently and/or collectively instructing or configuring the processing device to operate as desired. Software and/or data may be embodied in any type of machine, component, physical equipment, virtual equipment, computer storage medium and/or device, to be interpreted by the processing device and/or to provide an instruction and/or data to the processing device. The software also may be distributed over network coupled computer systems so that the software is stored and executed in a distributed fashion. The software and/or data may be stored by one or more computer readable storage media.

The methods according to the above-described example embodiments may be configured in a form of program instructions performed through various computer devices and recorded in computer-readable media. The computer-readable media may include, alone or in combination with program instructions, data files, data structures, and/or the like. The media may continuously store computer-executable programs and/or may transitorily store the same for execution and/or download. Also, the media may be various types of recording devices and/or storage devices in a form in which one or a plurality of hardware components are combined. Without being limited to media directly connected to a computer system, the media may be distributed over the network. Examples of the media include magnetic media such as hard disks, floppy disks, and/or magnetic tapes; optical media such as CD-ROM and/or DVDs; magneto-optical media such as floptical disks; and/or hardware devices that are specially configured to store program instructions, such as read-only memory (ROM), random access memory (RAM), flash memory, and/or the like. Examples of other media may include recording media and/or storage media managed by an app store that distributes applications and/or a site that supplies and distributes other various types of software, a server, and/or the like. Examples of program instructions include machine language code, such as that produced by a compiler, as well as high-level language code that may be executed by a computer using an interpreter and/or the like.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Although the example embodiments are described with reference to some specific examples and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, and/or circuit are combined in a different manner, and/or replaced or supplemented by other components or their equivalents.

Therefore, other implementations, other example embodiments, and equivalents of the claims are to be construed as being included in the claims.

What is claimed is:

1. A non-transitory computer-readable recording medium storing a computer program to execute an encryption method on a computer device in conjunction with the computer device, wherein the encryption method comprises:
generating, based on a media file to be transmitted in a streaming format, a plurality of encrypted unit files encrypted with a random key;
generating a plurality of hash values corresponding respectively to each of the plurality of encrypted unit files; and
transmitting the plurality of encrypted unit files and the plurality of hash values to a server configured to provide a transmission function of streaming format for the media file.

2. The non-transitory computer-readable recording medium of claim 1, wherein the encryption method further comprises:
encrypting the random key with a private key for end-to-end encryption; and
transmitting the random key encrypted with the private key to a terminal of a recipient that is allowed to play the media file.

3. The non-transitory computer-readable recording medium of claim 1, wherein the encryption method further comprises:
receiving, from a terminal of a provider of the media file, the random key encrypted with a private key of the provider for end-to-end encryption; and
acquiring the random key by decrypting the random key encrypted with the private key of the provider using a public key of the provider shared for the end-to-end encryption.

4. The non-transitory computer-readable recording medium of claim 1, wherein the encryption method further comprises:
receiving, from the server, the plurality of hash values;
receiving, from the server, a first encrypted unit file among the plurality of encrypted unit files;
generating a hash value of the first encrypted unit file using the random key acquired through a terminal of a provider of the media file; and
authenticating the first encrypted unit file by comparing the generated hash value and a received hash value of the plurality of received hash values corresponding with the first encrypted unit file.

5. The non-transitory computer-readable recording medium of claim 1, wherein the encryption method further comprises:
receiving, from the server, a first encrypted unit file among the plurality of encrypted unit files; and
acquiring a first unit file by decrypting the first encrypted unit file using the random key acquired through a terminal of a provider of the media file.

6. The non-transitory computer-readable recording medium of claim 1, wherein the encryption method further comprises:
receiving, from the server, the plurality of hash values;
requesting the server for a unit file of a specific order or a specific range based on an order of a hash value of the plurality of hash values; and
receiving, from the server, an encrypted unit file among the plurality of encrypted unit files corresponding to the specific order or the specific range.

7. An encryption method of a computer device comprising at least one processor, the encryption method comprising:
generating, by the at least one processor, a plurality of encrypted unit files encrypted with a random key, the plurality of encrypted unit files based on a media file to be transmitted in streaming format;
generating, by the at least one processor, a plurality of hash values corresponding respectively to each of the plurality of encrypted unit files; and
transmitting, by the at least one processor, the plurality of encrypted unit files and the plurality of hash values to a server configured to provide a transmission function of streaming format for the media file.

8. The encryption method of claim 7, further comprising:
encrypting, by the at least one processor, the random key with a private key for end-to-end encryption; and
transmitting, by the at least one processor, the random key encrypted with the private key to a terminal of a recipient that is allowed to play the media file.

9. The encryption method of claim 7, further comprising:
receiving, by the at least one processor from a terminal of a provider of the media file, the random key encrypted with a private key of the provider for end-to-end encryption; and
acquiring, by the at least one processor, the random key by decrypting the random key encrypted with the private key of the provider using a public key of the provider shared for the end-to-end encryption.

10. The encryption method of claim 7, further comprising:
receiving, by the at least one processor from the server, the plurality of hash values;
receiving, by the at least one processor from the server, a first encrypted unit file among the plurality of encrypted unit files;
generating, by the at least one processor, a hash value of the first encrypted unit file using the random key acquired through a terminal of provider of the media file; and
authenticating, by the at least one processor, the first encrypted unit file by comparing the generated hash value and a received hash value of the plurality of received hash values corresponding with the first encrypted unit file.

11. The encryption method of claim 7, further comprising:
receiving, by the at least one processor from the server, a first encrypted unit file among the plurality of encrypted unit files; and
acquiring, by the at least one processor, a first unit file by decrypting the first encrypted unit file using the random key acquired through a terminal of a provider of the media file.

12. The encryption method of claim 7, further comprising:
receiving, by the at least one processor from the server, the plurality of hash values;
requesting, by the at least one processor, the server for a unit file of a specific order or a specific range based on an order of a hash value of the plurality of hash values; and
receiving, by the at least one processor from the server, an encrypted unit file among the plurality of encrypted unit files corresponding to the specific order or the specific.

13. A computer device comprising:
at least one processor configured to execute computer-readable instructions,
wherein the at least one processor is configured to cause the computer device to,
receive, from a terminal of a provider of a media file to be transmitted in a streaming format, a plurality of encrypted unit files generated for the media file and a plurality of hash values corresponding respectively to each of the plurality of encrypted unit files,
transmit the plurality of hash values to a terminal of a recipient that desires to receive the media file in streaming format,
receive, from the terminal of the recipient, a request for a unit file of a specific order or a specific range based on an order of a hash value of the plurality of hash values, and
transmit, to the terminal of the recipient, an encrypted unit file of the plurality of encrypted unit files corresponding to the specific order or the specific range.

14. The computer device of claim 13, wherein the plurality of encrypted unit files are generated by
encrypting, at the terminal of the provider, the media file with a random key and then splitting the encrypted media file into the plurality of encrypted unit files, or
splitting, at the terminal of the provider, the media file into a plurality of unit files and then encrypting each of the plurality of unit files with the random key.

15. The computer device of claim 13, wherein a hash value of an encrypted unit file of the plurality of encrypted unit files corresponding to the specific order or the specific range is generated at the terminal of the recipient using a random key shared from the terminal of the provider based on end-to-end encryption, and the encrypted unit file corresponding to the specific order or the specific range is authenticated through comparison between the generated hash value and the transmitted hash value.

16. The computer device of claim 13, wherein an encrypted unit file of the plurality of encrypted unit files corresponding to the specific order or the specific range is decrypted at the terminal of the recipient using a random key shared from the terminal of the provider based on end-to-end encryption.
